(19) United States
(12) Patent Application Publication
(10) Pub. No.: US 2004/0156667 A1
(43) Pub. Date: Aug. 12, 2004

(54) Tamper resistant cosmetic stick container

(76) Inventors: Samuel Isaac Berger, Rego Park, NY (US); Aleksandar Bijelic, Raleigh, NC (US); Raymond Garofano, Pelham, NY (US); David Hoenig, East Brunswick, NJ (US); Jeffrey Wayne Mizell, Youngsville, NC (US); James Rudolph Rowland III, Kittrell, NC (US); James J. Thalheimer, Youngsville, NC (US)

Correspondence Address: JULIE BLACKBURN, REVLON CONSUMER PRODUCTS CORPORATION, 237 PARK AVENUE, NEW YORK, NY, 10017, US

(21) Appl. No.: 10/361,295

(22) Filed: Feb. 10, 2003

(51) Int. Cl. B43K 21/08

(52) U.S. Cl. 401/68

(57) ABSTRACT

A packaged cosmetic stick product comprising a (a) cosmetic composition containing, in a cosmetically acceptable carrier, at least one structuring agent in an amount sufficient to form a solid stick; said stick contained in a (b) a propel/repel container comprised of a (i) base for holding the cosmetic stick product wherein the cosmetic stick is partially extended therefrom, (ii) an A-shell affixed to the base and having length sufficient to completely house the cosmetic stick when it is in the fully retracted position, (iii) a transparent A-shell cover having a length that is less than about 80% of the total length of the A-shell, (iv) a shrink wrap holding the transparent A-shell cover to the A-shell, and (v) a cap for covering the A-shell and the transparent A-shell cover.

### TECHNICAL FIELD

The invention is in the field of tamper resistant closures for cosmetic products.

### BACKGROUND OF THE INVENTION

Cosmetic products that are damaged, destroyed, or stolen while on store shelves represent a significant cost to cosmetics companies. Generally stores order cosmetic products from the cosmetic manufacturer and place them on store shelves for consumer sale. A significant number of those products are damaged or destroyed while on store shelves, mostly by consumers. In a typical scenario, the consumer wants to better assess the color of the cosmetic product, such as lipstick, that she is considering buying. The consumer removes the cap from the lipstick and applies it to her body somewhere to assess color. Even if the consumer likes the color of the lipstick that was sampled and wants to buy it, the majority of consumers will not purchase the unit they sampled. In most cases the tested, and now damaged, unit will be returned to the store shelf and a new, sealed unit will be selected for purchase. At regular intervals store employees will take stock of the cosmetic products on their shelves and those that are damaged or destroyed are returned to the manufacturer for credit. Returns are not only a cost drain for the cosmetic company but the store that sells their products as well. Stores need employees to collect damaged items, pack and mail them back to the manufacturer, and maintain debit and credit records. Further, cosmetic products that have been tampered with can cause other types of damage in stores. For example, unsealed cosmetic products can spill and create messes, or be used to vandalize store fixtures and other products, so stores are also interested in creating cosmetic products that have adequate tamper resistant packaging.

With respect to lipsticks in particular, tamper resistant packaging is nothing new. For example, U.S. Pat. No. 4,422,545 is directed to a lipstick container where the entire cap is made of a clear thermoplastic material that enables the consumer to see the color of the lipstick bullet. One problem with this type of cap is that it is still removable by the consumer. Moreover, the cap itself must be clear, which means that one is fairly limited in the types of lipstick designs that can be used. Since lipstick component design is important in an image conscious business and serves to distinguish one brand from another, clear caps may not be desirable.

U.S. Pat. No. 4,208,144 is directed to another type of lipstick container that enables the consumer to view the color of the lipstick bullet within a narrow range in the middle section of the container. In particular, a plastic cover for the A-shell has a clear section that rests slightly above the intersection of the base portion and A-shell. The clear section has a wider circumference than the lipstick cap. When the cap is placed on the lipstick container, the clear band prevents the cap from completely seating and provides a viewing area for the lipstick bullet. One problem with this type of container is that the cap of the lipstick will not completely fit onto the base when the A-shell cover is in place. Further, viewing the color of the side of the lipstick may not completely satisfy the consumer who is intent on selecting the right lipstick shade because the actual physical lipstick bullet is not viewable.

U.S. Pat. No. 4,579,134 is directed to another type of tamper resistant lipstick container having a clear cap and a clear mid-portion. The lipstick bullet in retracted form can be viewed through the clear mid-portion. However, When the clear cap is in place, the lipstick bullet is viewed through two transparent layers, which may not provide the most accurate indication of color.

U.S. Pat. No. 5,257,704 teaches the use of a shrink wrap strip applied to the rotational assembly of the lipstick so that the consumer can remove the cap but cannot propel or repel the lipstick bullet.

U.S. Pat. No. 5,451,113 teaches another type of tamper resistant package where a clear plastic cover is fitted over the entire lipstick A-shell. The lipstick cap can be placed over the transparent cover if desired. When the consumer wants to look at the color of the lipstick bullet, the cap is removed and the lipstick is viewed through the clear A-shell. One problem with this type of tamper resistant package is that the clear plastic cover adds another layer of thickness to the A-shell and will interfere with the placement of the cap thereon. In some cases, if the lipstick cap is put on with too much force, it may crack.

U.S.D. 302,054 teaches a transparent A-shell extension through which the lipstick can be extended. While the transparent A-shell facilitates viewing of the lipstick bullet, the fact that the bullet can actually be extended and retracted through the top of A-shell doesn't address the breakage or damage problem at all.

There is a need for more effective tamper resistant packaging for cosmetic sticks products which caters to the consumer's desire to view the actual color of the stick prior to purchase, and at the same time prevent tampering.

It is an object of the invention to provide a tamper resistant package for cosmetic stick compositions that provides the consumer with a good view the color of the actual cosmetic product and at the same time prevents tampering.

It is a further object of the invention to provide a tamper resistant package for cosmetic stick compositions where the tamper resistant portion does not interfere with the operation of the case itself.

It is a further object of the invention to provide a tamper resistant package for cosmetic stick compositions which is inexpensive.

It is a further object of the invention to provide a tamper resistant package for cosmetic stick compositions which is easily removed by the consumer after the product is purchased.

### SUMMARY OF THE INVENTION

The invention is directed to a packaged cosmetic stick product comprising a (a) cosmetic composition containing, in a cosmetically acceptable carrier, at least one structuring agent in an amount sufficient to form a solid stick; said stick contained in a (b) a propel/repel container comprised of a (i) base for holding the cosmetic stick product wherein the cosmetic stick is partially extended therefrom, (ii) an A-shell affixed to the base and having length sufficient to completely house the cosmetic stick when it is in the fully retracted position, (iii) an A-shell cover having a length that is less than about 80% of the total length of the A-shell, (iv) a shrink wrap holding the A-shell cover to the A-shell, and (v) a cap for covering the A-shell and the A-shell cover.

### BRIEF DESCRIPTION OF THE DRAWINGS

FIG. 1: depicts one embodiment of the external appearance of the cosmetic container of the invention, which is in the closed position.

FIG. 2: depicts one type of A-shell cover.

FIG. 3: depicts the cosmetic container of the invention in the open position with the cap removed and the cosmetic stick fully retracted and not visible in side view.

FIG. 4: depicts the container of FIG. 3 wherein the cosmetic stick found therein is fully extended.

FIG. 5: is a side cutaway view of the cosmetic container of FIG. 1 showing the A-shell cover of FIG. 2 affixed to the A-shell without shrink wrap and the cosmetic stick in semi-extended position within the base.

FIG. 5A: is a side cutaway view of the cosmetic container of FIG. 1 showing the A-shell cover of FIG. 2 affixed to the A-shell with shrink wrap and the cosmetic stick in semi-extended position within the base.

FIG. 5B: is a side cutaway view of the cosmetic container of FIG. 1 showing the A-shell cover of FIG. 7 affixed to the A-shell with shrink wrap and the cosmetic stick in semi-extended position within the base.

FIG. 6: illustrates is a side cutaway view of one container in accordance with the invention that shows the cosmetic stick partially extended from the base and covered by another type of A-shell cover that rests on the A-shell but is not attached with shrink wrap.

FIG. 7: shows the A-shell cover that is depicted in FIGS. 5B and 6.

FIGS. 8A-C: illustrate the various components that make up the base.

FIG. 8A: depicts the cup for holding the cosmetic stick.

FIG. 8B: depicts the dispenser base.

FIG. 8C: depicts an outer shell.

FIG. 8D: depicts the A-shell.

FIG. 9: is a top plan view of the cup, dispenser base, outer shell and A-shell in fully assembled position.

FIG. 10: is a top plan view of the cup of FIG. 8A.

FIG. 11: is a top plan view of the dispenser base of FIG. 8B.

FIG. 12: is a top plan view of the outer shell of FIG. 8C.

FIG. 13: is a top plan view of the A-shell of FIG. 8D.

FIG. 14: is a side cutaway view of the cosmetic container of the invention having the A-shell cover of FIG. 2 affixed to the A-shell without shrink wrap.

FIG. 15: is a side cutaway view of the cosmetic container of the invention having the A-shell cover of FIG. 7 affixed to the A-shell without shrink wrap.

### DETAILED DESCRIPTION

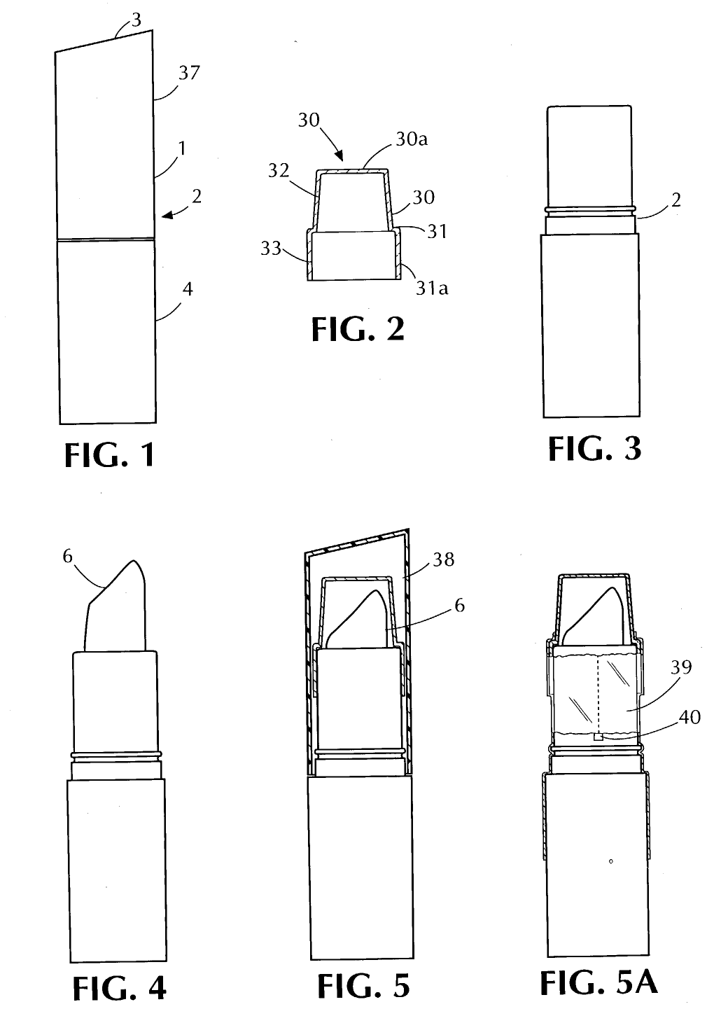

FIG. 1 depicts the packaged cosmetic product 1 of the invention, which is housed in a container 2 in the closed position. The container has a cap 3 and a base 4. In FIG. 1 the cap 3 is affixed to the base 4. The container is a propel/repel container, which means that the container contains a mechanism (to be further described herein) that enables the cosmetic stick to be “propelled” or extended from the base and “repelled” or retracted back into the base when desired.

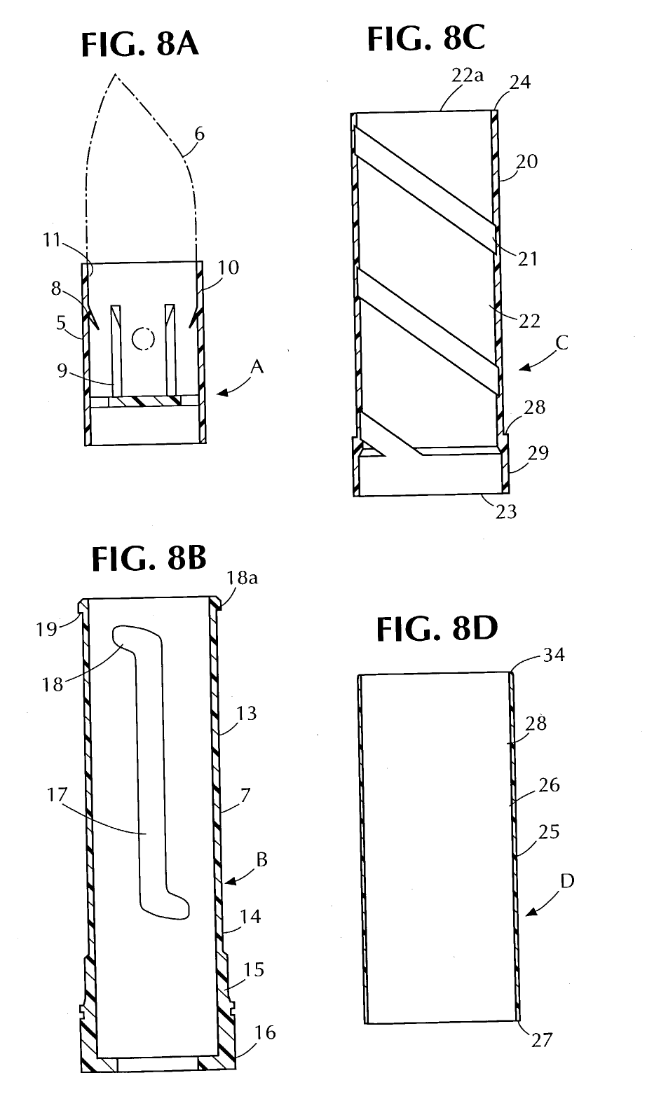

The various components that make up the base 4 are illustrated in FIGS. 8A-C. FIG. 8A depicts a side view what is referred to as a cup 5, and FIG. 10 is a top plan view of the cup 5. FIG. 8B depicts the dispenser base 7 in side view and FIG. 12 is a top plan view. FIG. 8C depicts the side view of the outer shell 20 and FIG. 12 a top plan view.

The cup 5 as shown in FIG. 8A holds the cosmetic stick product 6, the cosmetic stick being depicted with broken lines.

The cosmetic stick contains at least one structuring agent or combination of structuring agents in an amount sufficient to enable formation of a cosmetic stick. The term “cosmetic stick” means any self supporting cosmetic composition. The cosmetic stick used in the container of the invention may be anhydrous or aqueous. In the case where the sticks are anhydrous, they typically comprise one or more oily ingredients, such as silicones or organic oils; and the structuring agent, which causes the composition to form its self supporting structure. In addition such sticks may contain particulates and other ingredients to enhance their aesthetic properties. Oily ingredients include volatile and non-volatile silicones as well as organic oils in the form of esters, volatile or non-volatile paraffinic hydrocarbons, triglycerides, and so on. Particulates include include D&C or FD&C organic pigments, inorganic iron oxide pigments, or non-pigmentitious powders such as titanium dioxide, nylon, boron nitride, silica, polyethylene, and so on. Similarly aqueous sticks, which contain water, also may contain, in addition to one or more structuring agents, particulates, and other ingredients to enhance the beneficial properties of the stick. A variety of ingredients are suitable structuring agents including waxes that are animal, vegetable, mineral, or silicone waxes that are capable of providing sufficient viscosity or structure to the composition. Also suitable as structuring agents are polymeric materials including polyamides, ethylene homo- and copolymers, or polymers comprised of other ethylenically unsaturated monomers such as acrylic acid, methacrylic acid, simple esters of acrylic or methacrylic acid, styrene, ethylene, vinyl pyrrolidone, vinyl acetate, urethanes, and so on. Generally, anhydrous sticks preferably contain, by weight of the total composition, about 0.001-95% oily ingredients, about 0.001-99% of one or more structuring agents, and about 0.001-50% of one or more particulates. Aqueous based sticks preferably comprise from about 0.001-85% water, 0.001-30% oily ingredients, 0.001-75% of one or more structuring agents, and 0.001-50% of one or more particulate materials. Examples of suitable cosmetic stick compositions and the ingredients found therein are set forth in U.S. Pat. Nos. 5,505,937; 5,725,845; and 6,162,421; and 6,042,815 all of which are hereby incorporated by reference in their entirety.

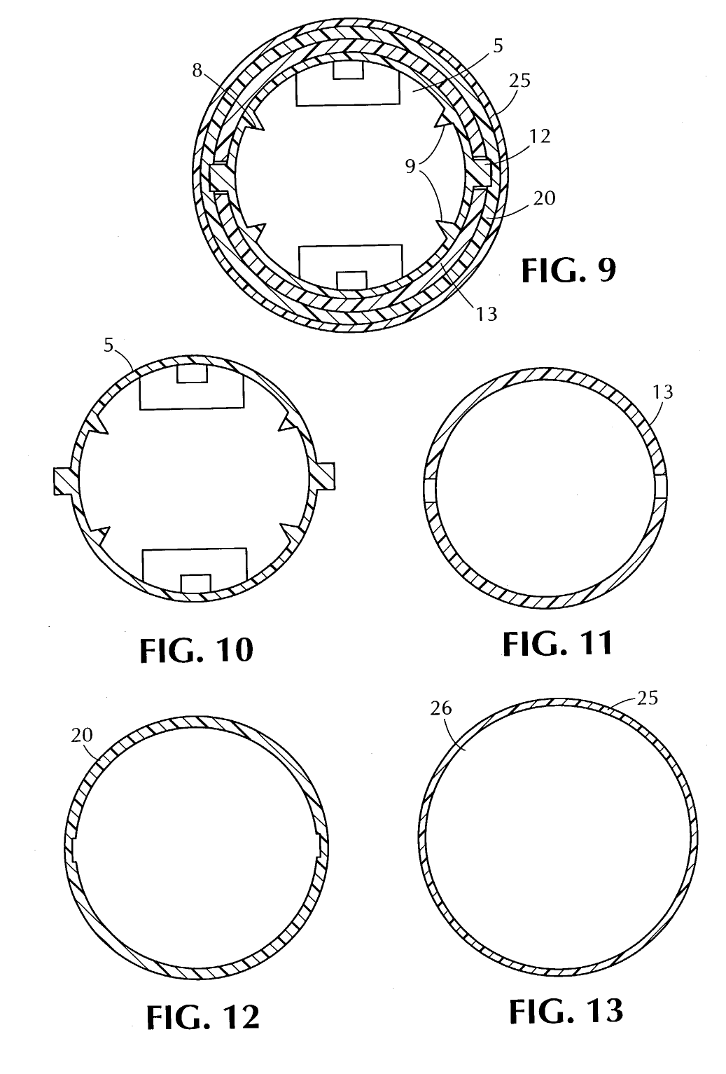

Preferably the cosmetic stick 6 that is used in the container 1 of the invention is prepared in the usual manner by pouring the molten cosmetic product into molds and cooling. The resulting cosmetic stick 6, also known as a “bullet”, is removed from the mold when hardened and fitted into the cup 5. The base of the cosmetic stick 6 fits into the cup 5 and the tip of the cosmetic stick is free. Preferably the cup 5 has barbs or splines 8 which assist in anchoring the cosmetic stick 6 in the cup 5. An example of such barbs is set forth in U.S. Pat. No. 6,116,801, which is hereby incorporated by reference in its entirety. The cup may also contain longitudinally extending ribs 9. While it is preferred that the cup 5 be circular in cross section, it is possible that the cup 5 may be oval, square, or other shapes. The cup 5 has an outer surface 10 and an inner surface 11. On the cup 5 outer surface 10 are a pair of cam followers 12 (see FIG. 9), which are generally cylindrical members spaced about 180° apart.

FIGS. 8B and 11 illustrate another component of the base 4 which is a dispenser base 13. The dispenser base 13 is a hollow tubular member which has a first segment 14 of varying diameter, and a second segment 15 of varying diameter, and an external base 16. Segments 14 and 15 and external base 16 have longitudinal axes in alignment. Segment 14 is formed with a pair of elongated openings 17 terminating at either end by a lateral opening 18. The openings 17 are generally spaced about 180° apart, with only one such opening being shown. Dispenser base 13 contains a surrounding rib 18A which contains an underlying lip 19 which circumscribes the dispenser base 13.

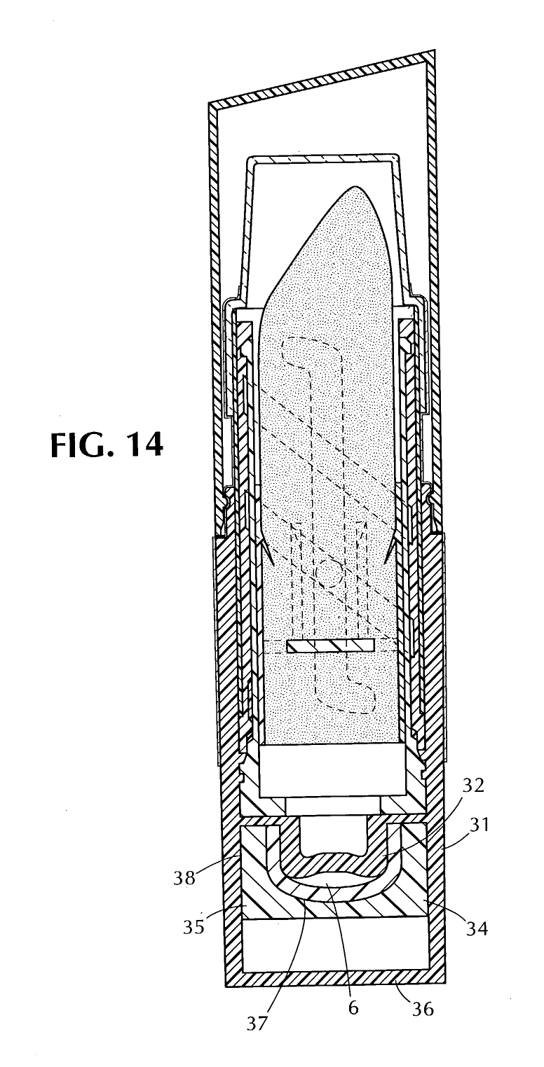

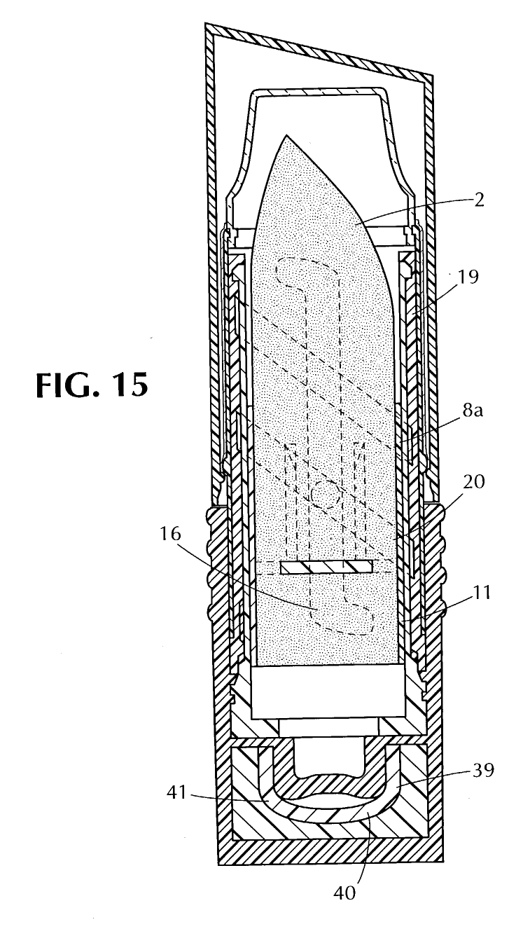

FIGS. 8C and 12 depict another component of the base 4, which is the outer shell 20. The outer shell 20 is a hollow tubular member having an inside diameter slightly larger than the external diameter of dispenser base 13. The outer shell 20 contains an external spiral shaped groove 21 formed in the interior surface 22 thereof. The spiral shaped groove 21 communicates between open ends 22A and 23 of outer shell 20. Outer shell 20 is positioned over dispenser base 13 as best depicted in FIGS. 14 and 15. Due to the slight dimensional differences between outer shell 20 and dispenser base 13, the outer shell 20 is rotatable about its longitudinal axis. In this arrangement, the spiral groove 21 is arranged such that it overlies openings 17 and 18 at various positions there along as the outer shell 20 is rotated. The outer shell 20 is retained in position by rib 18A with underlying lip 19 which fits over open end 22A of outer shell 20 with the underlying lip 19 fitting over the edges 24 of outer shell 20.

The cup 5, dispenser base 13, and outer shell 20 are assembled in nested relationship as depicted in FIG. 9.

FIG. 8D illustrates an external sleeve 25 referred to as the “A-shell”. The A-shell 25 has an inner diameter 26 that is slightly larger than the external diameter of outer shell 20. The A-shell 25 is also positioned in a nested relationship with cup 5, dispenser base 13, and outer shell 20 as depicted in FIG. 9. Preferably, the outer shell 20 is secured in the A-shell by glue or similar such that it is permanently affixed thereto. Accordingly, then the consumer desires to propel or repel the cosmetic stick in the container, gripping the base 4 with one set of fingers and the A-shell 25 with the other set of fingers, then rotating the A-shell 25 or the base 4 will cause the stick to propel or repel from the container.

In particular, the A-shell 25 has a bottom edge 27, which snugly fits against circumferential shelf 28 found on the lower portion 29 of outer shell 20. The consumer grips A-shell 25 with the fingers of one hand and the external base 16 with the fingers of the other hand. When the external base 16 is rotated in one direction the cosmetic stick 6 is extended from the container 2. When the external base 16 is rotated in the opposite direction, the cosmetic stick 6 is retracted into the container 2. Together the parts depicted by FIGS. 8A-D form the rotational assembly of the container, meaning that the parts work together to enable extension and retraction of the cosmetic stick 6 from the container 2.

FIGS. 2 and 7 depict the types of A-shell covers 30 that may be used with the cosmetic product 1 of the invention. These A-shell covers are generally made of a thermoplastic polymeric material which is preferably transparent either in whole or in part so that the consumer can see the color of the cosmetic stick 6 within the container 2.

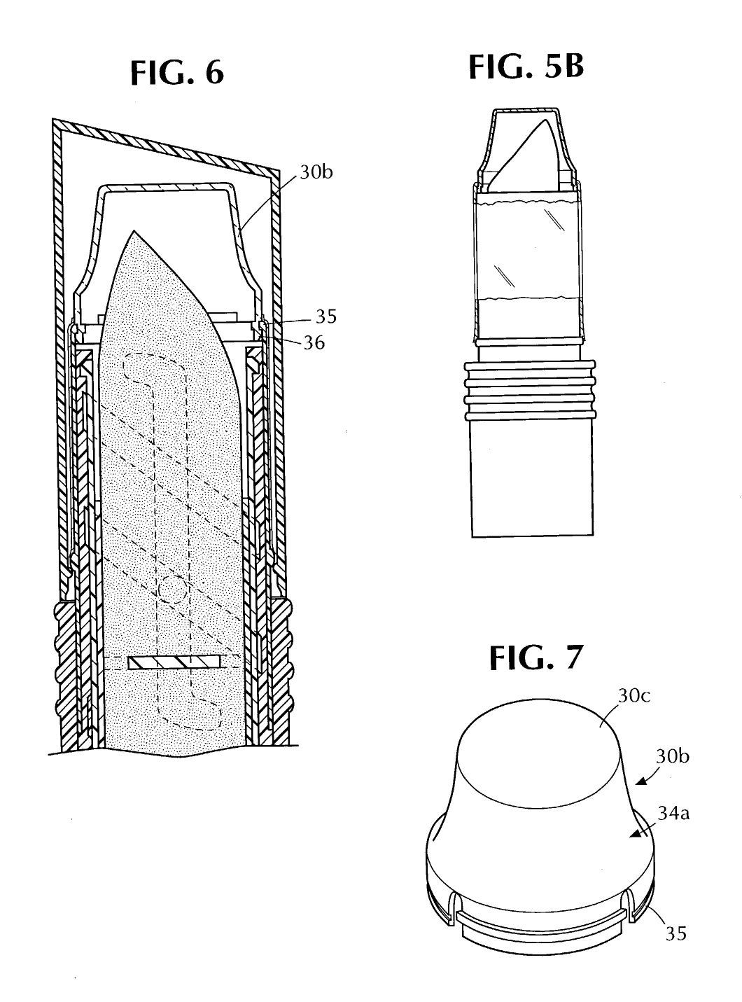

The A-shell cover 30 of FIG. 2 contains a closed cover 30A having a shoulder 31 and depending peripheral skirt 31A. The A-shell cover 30 is preferably completely transparent. The closed cover 30A has side walls 32 and the depending peripheral skirt 31A has side walls 33. The length of the side walls 32 of the closed cover is approximately about the same as the side walls 33 of the depending peripheral skirt 31A although that configuration is not necessary. The shoulder 31 rests on the top surface 34 of the A-shell 25 as depicted in FIG. 5.

FIG. 7 depicts yet another type of A-shell cover 30B suitable for use with the packaged cosmetic product 1 of the invention. This A-shell cover 30B has a closed cover 30C with side walls 34A and a very small shoulder 35 of a size and shape sufficient to sit directly on the top surface 34 of A-shell 25. A-shell cover 30B has a small gripping member 36. As is depicted in FIG. 6, the shoulder of A-shell cover 30B rests on the top surface 34 of A-shell 25 and the gripping member 36 extends for a very small distance down into the A-shell 25 internal surface to stabilize the A-shell cover 30B on the A-shell 25, preferably by exerting a friction fit. In particular, the gripping member forms a friction fit against the A-shell 25 internal surface to further stabilize this A-shell cover on the top surface 34 of the A-shell.

In both cases, the thickness of the A-shell cover 30 and 30B is such that the cap 37 inner surface 38 does not come into contact with the A-shell cover 30 or 30B. This is important because any additional bulk provided by the A-shell cover or shrink wrap or both will impact how the cap fits onto the container. In particular, if the A-shell cover and shrink wrap provide too much additional bulk, the cap will not fit onto the container, or will have to be forced onto the container. This may cause the cap to crack.

As is best depicted in FIG. 5A, the A-shell cover is preferably attached to the A-shell by what is referred to as “shrink wrapping” 39, which is a clear thermoplastic polymeric sealing laminate that holds affixes the A-shell cover to the A-shell. Typically shrink wrap is made from thermoplastic polymeric materials such as polyolefins, polycycloolefins, polyethylene, and the like. If desired, the shrink wrapping 39 that secures the A-shell cover to the A-shell may be imprinted with various indicia such as the lipstick ingredient list, the name of the company manufacturer, and so on. If desired the shrink wrap can have a tearaway tab 40 which enables the consumer who purchases the product to grip the tearaway tab 50 with the fingers and thereby easily remove the shrink wrap 39. After the shrink wrap 39 is removed, the A-shell cover will loosen and can be removed, and the lipstick can be dispensed from the base in the traditional manner.

The shrink wrap 39 not only secures the A-shell cover to the A-shell, but also prevents turning of the rotational assembly in, the lipstick base to propel and repel the stick. Until the shrink wrap 39 is removed by the consumer, the lipstick cannot be tested, operated, or tampered with, yet the consumer is fully able to view the bullet color and shape.

The product of the invention addresses the consumer's need to actually view the color and shape of the cosmetic stick within the container, and even remove the cap of the container but will otherwise prevent any tampering activities. The result is substantial cost savings due to amelioration of damaged goods.

While the invention has been described in connection with the preferred embodiment, it is not intended to limit the scope of the invention to the particular form set forth but, on the contrary, it is intended to cover such alternatives, modifications, and equivalents as may be included within the spirit and scope of the invention as defined by the appended claims.

We claim:

1. A packaged cosmetic stick product comprising a (a) cosmetic composition containing, in a cosmetically acceptable carrier, at least one structuring agent in an amount sufficient to form a solid stick; said stick contained in a (b) a propel/repel container comprised of a (i) base for holding the cosmetic stick product wherein the cosmetic stick is partially extended therefrom, (ii) an A-shell affixed to the base and having length sufficient to completely house the cosmetic stick when it is in the fully retracted position, (iii) a transparent A-shell cover having a length that is less than about 80% of the total length of the A-shell, (iv) a shrink wrap holding the transparent A-shell cover to the A-shell, and (v) a cap for covering the A-shell and the transparent A-shell cover.

2. The product of claim 1 wherein the base comprises, in combination, (i) a cup for holding the cosmetic stick, (ii) a dispenser base, and (iii) an outer shell.

3. The product of claim 2 wherein the cup has barbs.

4. The product of claim 3 wherein the cup further contains longitudinally extending ribs.

5. The product of claim 4 wherein the cup has an outer surface and an inner surface, and on the outer surface thereof there are cam followers which are cylindrical members spaced about 180° apart.

6. The product of claim 2 wherein the dispenser base is a hollow tubular member having an external base.

7. The product of claim 6 wherein the hollow tubular member further comprises a first segment of varying diameter and a second segment of varying diameter and both segments have longitudinal axes in alignment.

8. The product of claim 7 wherein the first segment of varying diameter has a pair of elongated openings terminating at either end by a lateral opening and such lateral openings are generally spaced about 180° apart.

9. The product of claim 8 wherein the dispenser base contains a surrounding rib that circumscribes the dispenser base.

10. The product of claim 2 wherein the outer shell is a hollow tubular member having an internal diameter that is slightly larger than the external diameter of dispenser base, and further having an external spiral shaped groove formed in the interior surface thereof.

11. The product of claim 10 wherein the outer shell contains two open ends and the spiral groove communicates between the open ends thereof.

12. The product of claim 2 wherein the A-shell has an internal diameter that is slightly larger than the external diameter of the outer shell.

13. The product of claim 2 wherein the A-shell cover has a closed cover having a shoulder and a depending peripheral skirt.

14. The product of claim 13 wherein the A-shell has a top surface and the shoulder of the A-shell cover rests on the top surface of the A-shell when the A-shell cover is in place.

15. The product of claim 2 wherein the A-shell cover has a closed cover with side walls, a shoulder, and a gripping member for securing the A-shell cover to the A-shell.

16. The product of claim 15 wherein the A-shell has a top surface and an internal surface, and the shoulder of the A-shell cover rests on the top surface and the gripping member of the A-shell extends for a short distance into the internal surface of the A-shell.

17. A packaged lipstick product comprising (a) a lipstick containing, in a cosmetically acceptable carrier, at least one structuring agent in an amount sufficient to form a solid stick; said stick contained in a (b) a propel/repel container comprised of a (i) base for holding the lipstick product wherein the lipstick is partially extended therefrom, (ii) an A-shell affixed to the base and having length sufficient to completely house the cosmetic stick when it is in the fully retracted position, (iii) a transparent A-shell cover having a length that is less than about 80% of the total length of the A-shell, (iv) a shrink wrap holding the transparent A-shell cover to the A-shell, and (v) a cap for covering the A-shell and the transparent A-shell cover.

18. The lipstick product of claim 17 wherein the A-shell cover is transparent.

19. The lipstick of claim 17 wherein the shrink wrap is transparent.

20. The lipstick of claim 17 wherein the shrink wrap has a tearaway tab.
